(19) United States
(12) Patent Application Publication
(10) Pub. No.: US 2020/0073925 A1
(43) Pub. Date: Mar. 5, 2020

(54) METHOD AND SYSTEM FOR GENERATING A WEBSITE FROM COLLECTED CONTENT

(71) Applicants: Stephen Londy Shapiro, Carbondale, CO (US); Philip Carter Drew, Carbondale, CO (US)

(72) Inventors: Stephen Londy Shapiro, Carbondale, CO (US); Philip Carter Drew, Carbondale, CO (US)

(21) Appl. No.: 16/561,220

(22) Filed: Sep. 5, 2019

Related U.S. Application Data
(60) Provisional application No. 62/727,240, filed on Sep. 5, 2018.

(51) Int. Cl. G06F 17/24; G06F 16/903

(52) U.S. Cl. CPC G06F 17/248; G06F 16/90335

(57) ABSTRACT

The present invention is a computer-implemented method comprising searching a plurality of sources for topics, wherein the topics are associated with distinct entities, identifying a vertical for each of the topics, wherein the vertical is based on the type of distinct entity associated with each topic, sorting the plurality of sources into a group of content sources associated with each of the identified topics, extracting content items from the group of content sources associated with an identified topic, decompiling the group of content items, wherein each of the content items are decompiled into a content type and a set of data, selecting a template based on the topics vertical, and populating the template with the decompiled group of content items, wherein predetermined entries in the template are related to specific content types.

### CROSS-REFERENCE TO RELATED APPLICATIONS

This application is a continuation (and claims the benefit of priority under 35 USC 120) of U.S. application No. 62/727,240 filed Sep. 5, 2019. The disclosure of the prior applications is considered part of (and is incorporated by reference in) the disclosure of this application.

### BACKGROUND

This disclosure relates generally to website creation, and more particularly to a method, computer program and computer system's automatic website creation and management by combining associated content related to a topic.

The advent of the World Wide Web (the “web”) has presented the public with access to an unprecedented amount of easily available information. This has made publishing information on the web attractive for those who wish to disseminate information rapidly and widely. However, with the many different sources which one can publish information, the difficulty in creating a quality website, and the expensive and time required update and maintaining a website has hindered many companies, groups, and individuals from creating and maintaining a website to centralize all of their content. It is generally difficult for novice users to publish information onto a website since technical skill is required to set up and maintain a website, and a great deal of effort is required to organize and generate information in an aesthetically pleasing way. Thus, the time required to create and maintain a website has become for many a significant problem.

For example, even if a user only wants to put a few photos on the web with a minimum of comments, he or she must typically invest considerable time and effort to resize the photos, create thumbnails, and make sure the comments appear properly next to each picture. Likewise, if a busy professional wants to “share” information online (i.e., place information on the Internet or an intranet) about his or her career in order to advertise skills or to attract colleagues with similar interests, he or she may spend an entire day just creating the website and/or mobile variant of the website, and consequently lose interest in adding information to the site later or in keeping it up-to-date. Users learn quickly that creating websites is “hard” and is not worth the trouble. Furthermore, the degree to which many “homemade” websites are not user friendly has been a central topic of discussion among website usability and design professionals; many websites lack even the most basic accessibility support to make them readable by visually impaired persons, for example.

Programs have been made to simplify this process. Many programs are available that allow for drag and drop methods for creating websites (or websites). Using these methods, one can select, for example, a horizontal border, a headline object, or a link object and place it on the website. Automatic website builders, which are available on the web, give the user a series of forms to fill out and then automatically creates a website from that information.

These programs and systems, however, do not make it any easier to give the website a desired appearance or layout, which in itself can be a time-consuming and difficult process. The user must still fill out a form indicating text, color, and size for many of the objects, and the link object requires the user to type in the path to the linked data for every piece of data. If the user wishes to share, say, 30 documents, this can be time consuming, as it is still quite difficult to associate data with the layout of the website. In short, these programs are best suited for professionals who create professional websites.

Professionals and those alike may simplify the process of creating a website, however, they do not automate the process, content creation, and associated formatting. The user typically must upload each file to a server and then gives details of how the data will be presented, e.g., what the link anchor text will be, whether it is a bullet list for each file, and so on. Many of these tools also force the user to choose a template for the layout of the website before entering any information.

Even when the entity is able to create the website, they still must constantly update and maintain the website as they publish new content in other sources and services. Thus, creating an additional step for the entity.

There remains a need for automating the process of creating and maintaining a web site.

### SUMMARY

In a first embodiment, the present invention is a computer-implemented method comprising: searching, by one or more processors, a plurality of sources for topics, wherein the topics are associated with distinct entities; identifying, by one or more processors, a vertical for each of the topics, wherein the vertical is based on the type of distinct entity associated with each topic; sorting, by one or more processors, the plurality of sources into a group of content sources associated with each of the identified topics; extracting, by one or more processors, content items from the group of content sources associated with an identified topic; decompiling, by one or more processors, the group of content items, wherein each of the content items are decompiled into a content type and a set of data; selecting, by one or more processors, a template based on the topics vertical; and populating, by one or more processors, the template with the decompiled group of content items, wherein predetermined entries in the template are related to specific content types.

In a second embodiment, the present invention is a computer program product for generating a website, the computer program product comprising a computer readable storage medium having program instructions embodied therewith, the program instructions executable by one or more processors to cause the computing device to: program instructions to search a plurality of sources for topics, wherein the topics are associated with distinct entities; program instructions to sort the plurality of sources into a group of content sources associated with each of the topics; program instructions to extract content items from the group of content sources associated with the topic; program instructions to decompile the group of content items; program instructions to select a template; and program instructions to populate the template with the decompiled group of content items.

In a third embodiment, the present invention is a system comprising: a CPU, a computer readable memory and a computer readable storage medium associated with a computing device; program instructions to search a plurality of sources for content topics, wherein the content topics are associated with individual entities; program instructions to sort the plurality of sources into groups based on the content topics associated with each of the sources from the plurality of sources; program instructions to extract content items associated with the content topic from the group of relevant sources; program instructions to decompile the content items, wherein each of the content items are decompiled into a set of fields associated with a type of content; and program instructions to populate a template with the decompiled content items based on the content types, wherein a website is formed.

### BRIEF DESCRIPTION OF THE DRAWINGS

Referring now to the drawings in which like reference numbers represent corresponding parts throughout:

FIG. 1 depicts a cloud computing node, according to an embodiment of the present invention.

FIG. 2 depicts a cloud computing environment, according to an embodiment of the present invention.

FIG. 3 depicts abstraction model layers, according to an embodiment of the present invention.

FIG. 4 depicts a block diagram depicting a computing environment, according to an embodiment of the present invention.

FIG. 5 depicts a flowchart of the operational steps taken to categorize Content Items using a computing device within the computing environment of FIG. 4, according to an embodiment of the present invention.

FIG. 6 depicts a diagram of the operational steps taken to locate Topics based on searching various Content Sources, according to an embodiment of the present invention.

FIG. 7 depicts a diagram of the operational steps taken identify Content Sources for the specific Topic, according to an embodiment of the present invention.

FIG. 8 depicts a diagram of the operational steps taken to categorize Content Items by Type which are extracted from the Content Sources, according to an embodiment of the present invention.

FIG. 9 depicts a flowchart of the operational steps taken to populate a template using a computing device within the computing environment of FIG. 4, according to an embodiment of the present invention.

FIG. 10 depicts a flowchart of creating a website and populating the template, according to an embodiment of the present invention.

FIG. 11 depicts a diagram of a Template website layout, according to an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects may generally be referred to herein as a “circuit,” “frame”, or “system.” Furthermore, aspects of the present invention may take the form of a computer program product embodied in one or more computer readable medium(s) having computer readable program code/instructions embodied thereon. The system, method, or computer program product provides the benefit of facilitating content extraction from a multitude of sources on a per entity basis. The flexibility in structure and design, due to the ever-evolving number of content items and types that may be available and associated with an entity. The extracted content is based on the plethora or limited amount of web presence.

The present invention provides a system and method for the automatic generation and maintenance of a website for various Topics. Throughout the World Wide Web's history, websites have been created for millions, possibly billions, of Topics s. Those Topics include the representation of a person (i.e. “Barak Obama”), a place (i.e. “The Middle East”), or thing (i.e. “XYZ Coffee Shop” or a concept such as “Astronomy”).

A “web presence” is the combination of all locations on the World Wide Web where the Topic is represented. Examples of items found in a web presence could be a website, a microsite, a review, a wiki page, or a social media point of presence (e.g., a LinkedIn company page, a Facebook page, or a Twitter account).

Each Topic's website in the program may be created automatically, without the consent of a representative of the Topic through the use of publicly accessible content found within content sources. Due to the content being publicly available there is no intrusion into the topic's private or personal information. In some instances, content is searched to remove content which could be personal or private. Once created, a representative of the Topic may choose to claim ownership in order to curate the website's content.

The present invention provides in various embodiments a program facilitating content extraction from a multitude of sources specific to a single Topic. The program allows flexibility in structure and design, due to the substantially continuous number of Content Items and Types that may be available and associated with the Topic. In some embodiments, extracted content is quite limited due to the Topic's limited web-presence (i.e. a small number of content sources which are related to the Topic). In other embodiments, the amount of content is quite large due to a larger web-presence.

The present invention generally relates to creating a web site from publicly accessible content for Topics (persons, groups, companies, etc.) that is both efficiently and aesthetically designed based on the publicly accessible content, and also up-to-date based on the Topic's generated content. This alleviates the entity's need to go through the lengthy and tiresome process of creating the website. Additionally, providing the entity with updates based on future created content through the various sources they may already be using.

The technical field may relate to automatic website creation in an opt-out, rather than opt-in, model. More specifically, to a method and system to identify people, places and things (e.g. Topics). Then, for each Topic, automatically build and maintain a website by combining a multitude of associated content sources (i.e. Facebook, Twitter, YouTube etc.) which offer publicly accessible Content Items.

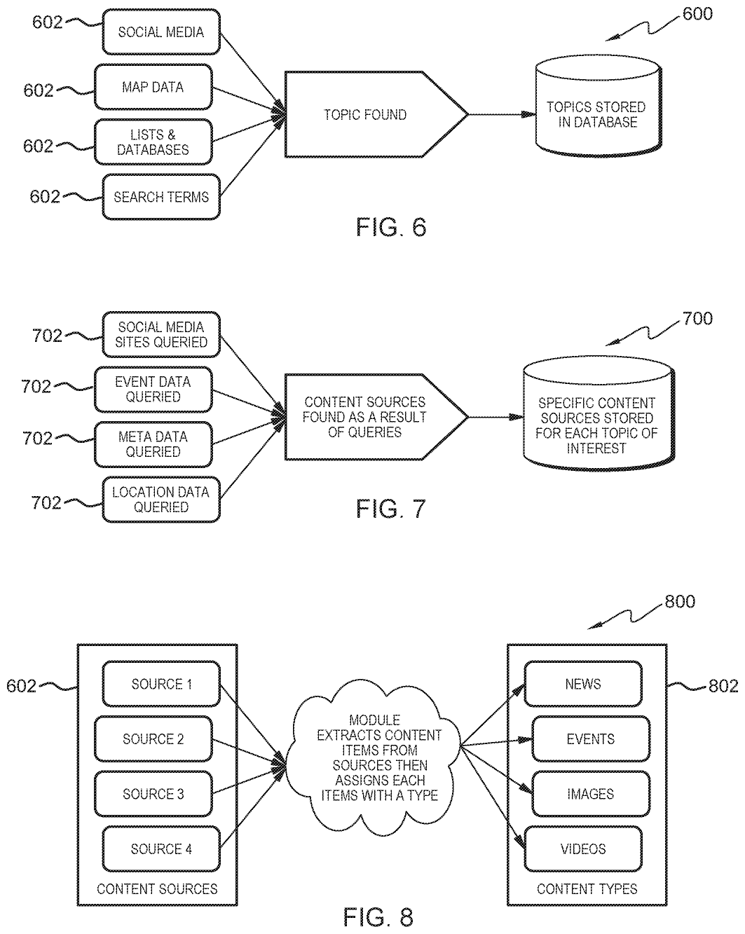

Finding Topics may be accomplished in a multitude of methods (As described a below and shown in FIG. 6). One excellent source can be found in social media sites such as Facebook, LinkedIn and Wikipedia in which pages and groups are often dedicated to Topics. In Facebook alone, limited to North America, there are more than 30 million pages representing Topics of all kinds. In addition, lists are available (usually for purchase) via specialized list providers. For Topics with an address, map tools (such as Google Maps) make data available which produce huge quantities of Topics (more than 13 million are available today in Google Maps). Lastly, one could build a list by evaluating common search phrases in common search engines. For example, current trending phrases are “Schamburg” (a place), “Illinois” (a place), “NBA” (a thing), & “Tropper” (a person).

3rd party sources of content, such as LinkedIn, Wikipedia, Google, Facebook and countless more are considered Content Networks (“Content Networks”). 3rd party public content is any content which is retrievable programmatically over the Internet without the content creator's consent. For example, there are 510,000 comments and 136,000 photos posted on average per minute on Facebook worldwide for those posts, comments and photos which are made public, are accessible to persons and programs alike. The most common method to retrieve content by a program from a Content Network is by an Application Protocol Interface (API) defined by and offered by the Content Network.

A website's purpose is to inform a viewer of the Topic's news, events, announcements and more including access to an array of media including audio, video and imagery. Each of these are considered a Type (“Content Type”) and the individual pieces of content are considered Content Items (“Content Items”).

A website is maintained by some person or persons associated with the Topic. For example, an employee, department of a company, or an enthusiast of a topic, might manage a Topic's website. That same person(s) may also maintain the Topic's other elements of its Web Presence or other person(s) may contribute to the web presence for any given Topic.

Since each Content Network identifies its content differently, it's often difficult to find commonalities between Content Networks even though the underlying content has the same purpose. For example, twitter might call a post a “Tweet” while Facebook calls a post a “message.” An additional example is found in the countless ways in which events are identified. An event created in Facebook and an event created in Google Calendar may be retrieved via API and/or web-crawler and/or the parsing of the calendar's ICS file. Each of these methods cause different content to be retrieved even though they may refer to the same content item.

The Content Network may name the content differently (i.e. a “tweet” vs. a “post) but it is also true that intention of these Content Items often overlaps. For example, a tweet, a message and a post may be considered of similar “type” due to their common purpose of posting a short message to an audience. Content such as events, news, videos and images are all considered Content Types. Often, the ability to identify the Type is difficult due to the unique offerings of a Content Network and the way in-which the content is received from the Content Network. Most often, the 3rd party content network itself helps associate the Content Item with a Type. For example, a YouTube Content Source would generally offer Content Items of Type “video.”

Significant time is being spent by representatives of Topics to create and manage their websites. Unfortunately, that time is largely doubled through the need to also participate in various 3rd party Content Networks (i.e. Facebook & Twitter). The amount of time spent on both the website and within Content Networks can be a significant drain on resources.

Countless applications currently exist to make the management of websites easier and faster. While they often achieve their goal, it does not alter the fact that any time spent on the website is heavily redundant to their time spent on Content Networks. Therefore, it would be advantageous to have a system that combines the content strategically from all associated Content Networks into a single website for each Topic in the world. Thus, eliminating the need for website creation and management.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

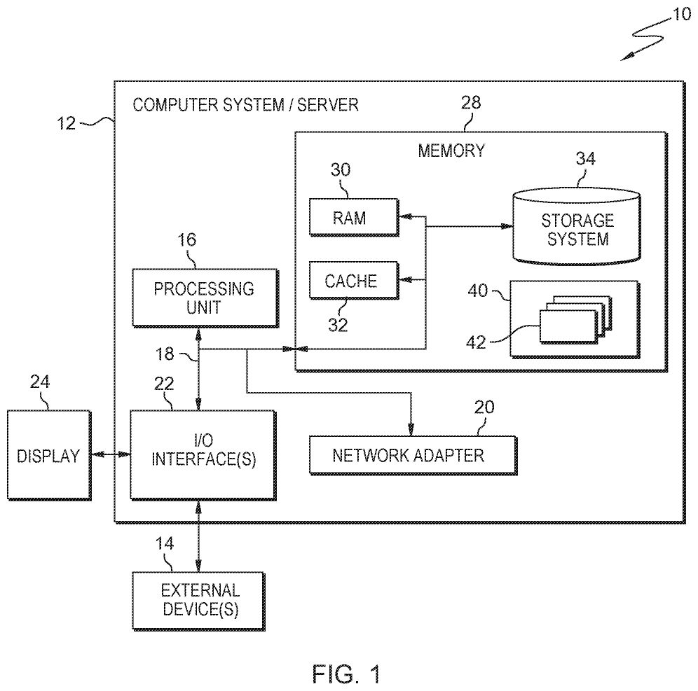

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purposes or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

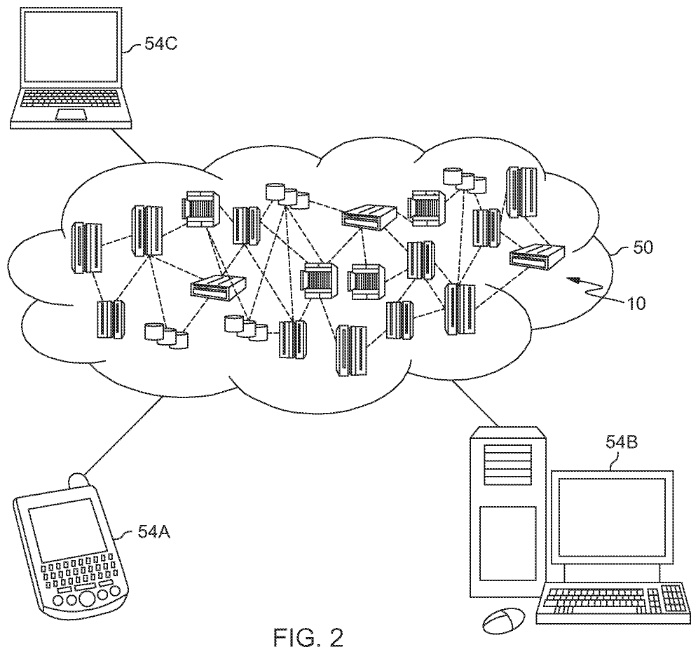

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, and laptop computer 54C may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

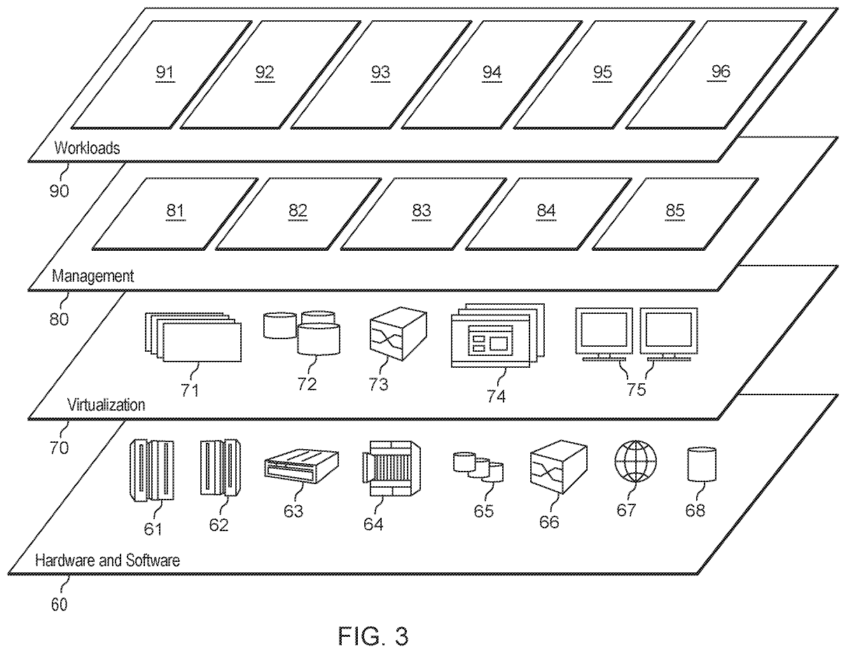

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 include hardware and software components. Examples of hardware components include mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and data collection 96.

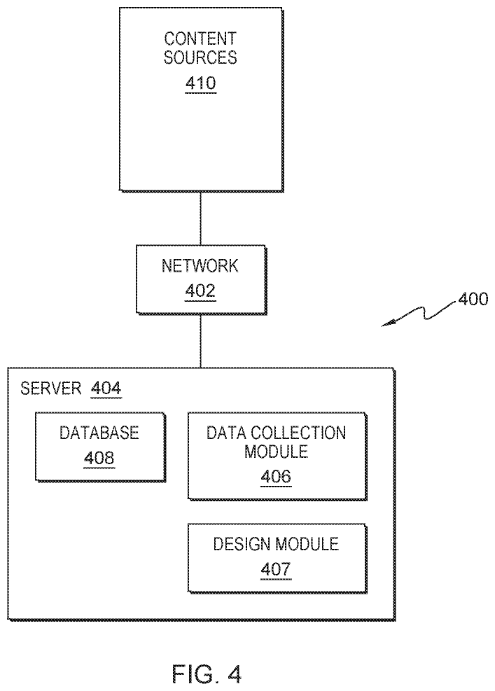

Referring back to FIG. 1, the Program/utility 40 may include one or more program modules 42 that generally carry out the functions and/or methodologies of embodiments of the invention as described herein. Specifically, the program modules 42 may monitor real-time parking facility camera data, receive vehicle identification information for a vehicle entering a parking facility, identify driver and vehicle information based on the vehicle identification information, identify open parking spaces based on the real-time parking facility camera data, determining attributes of the open parking spaces, score the open parking spaces based on the attributes, the vehicle information, and the driver information, select a particular open parking space based on the scoring, determine navigation directions to the selected parking space, and outputting navigation directions and information for the selected parking space, e.g., to a user device of the driver and/or to a vehicle interface system, such as a vehicle navigation system. Other functionalities of the program modules 42 are described further herein such that the program modules 42 are not limited to the functions described above. Moreover, it is noted that some of the modules 42 can be implemented within the infrastructure shown in FIGS. 1-3. For example, the modules 42 may be representative of a data collection module and design module as shown in FIG. 4.

FIG. 4 depicts a block diagram of a computing environment 400 in accordance with one embodiment of the present invention. FIG. 4 provides an illustration of one embodiment and does not imply any limitations regarding the environment in which different embodiments maybe implemented.

In the depicted embodiment, computing environment 100 includes network 402, server 404, and content sources 410. Computing environment 100 may include additional servers, computers, or other devices not shown.

Network 402 may be a local area network (LAN), a wide area network (WAN) such as the Internet, any combination thereof, or any combination of connections and protocols that can support communications between server 404 and content sources 410 in accordance with embodiments of the invention. Network 402 may include wired, wireless, or fiber optic connections.

Server 404 may be a management server, a web server, or any other electronic device or computing system capable of processing program instructions and receiving and sending data. In another embodiments server 404 may be a laptop computer, tablet computer, netbook computer, personal computer (PC), a desktop computer, or any programmable electronic device capable of communicating via network 402. In one embodiment, server 404 may be a server computing system utilizing multiple computers as a server system, such as in a cloud computing environment. In one embodiment, server 404 represents a computing system utilizing clustered computers and components to act as a single pool of seamless resources. In the depicted embodiment data collection module 406, design module 407, and database 408 are located on server 404. Server 404 may include components, as depicted and described in further detail with respect to FIG. 1.

Content source 410 are 3rd party sources of content, such as various social media networking service, websites, online content generators, such as, but not limited to LinkedIn®, Wikipedia®, Google®, Facebook® and countless more are considered Content Networks (“Content Networks”). The 3rd party sources are typically publicly accessible which is retrievable programmatically over the network 402. In some embodiments, consent is required, but the majority of instances consent is not required to access the public content. In the depicted embodiment, the content sources 410 are accessible by network 402.

Data Collection Module 406 operates to access the content sources 410 and collect the data (text, photos, videos, etc.) generated by various entities. Data Collection Module 406 categorized the content collected and stores the content to provide to the design module 407 when the website is ready to be generated. The Data Collection Module 406 parses one or more content source 410 to look for entity specific data or may collect all data associated with all entities present within the content sources 410. In the depicted embodiment, Data Collection Module 406 utilizes network 402 to access the content sources 410. In the depicted embodiment, Data Collection Module 406 resides on server 404. In other embodiments, Data Collection Module 406 may be located on another server or computing device, provided Data Collection Module 406 has access to database 408, content sources 410, and design module 407.

Design Module 407 operates to generate the templates used for the website generation, and populate the content related to the specific entities within the templates based on the type of content which was collected by the Data Collection Module 406. In the depicted embodiment, Data Collection Module 406 utilizes network 402 to access the content sources 410. In the depicted embodiment, Design Module 407 resides on server 404. In other embodiments, Design Module 407 may be located on another server or computing device, provided Design Module 407 has access to database 408, content sources 410, and data collection module 406.

Database 408 may be a repository that may be written to and/or read by Design Module 407 and Data Collection Module 406. Such information/data may include text, audio, photos, videos, and other types of information or data generated by the entity. In one embodiment, database 408 is a database management system (DBMS) used to allow the definition, creation, querying, update, and administration of a database(s). In the depicted embodiment, database 408 resides on server 404. In other embodiments, database 408 resides on another server, or another computing device, provided that database 408 is accessible to Data Collection Module 406 and Design Module 407.

The modules(s) (e.g. program(s), system(s), or component(s), application(s)) described herein and the steps identified are based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

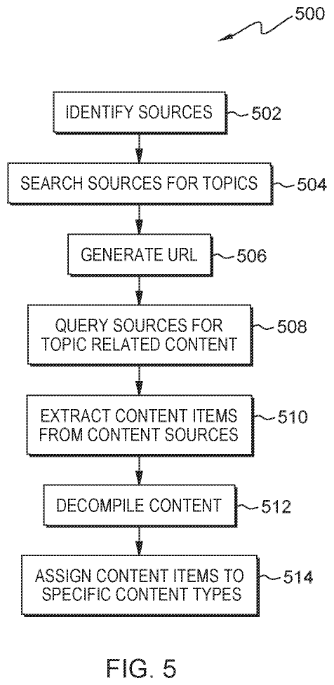

FIG. 5 shows flowchart 500 depicting a method according to the present invention. The method(s) and associated process(es) are now discussed, over the course of the following paragraphs, with extensive reference to FIG. 5, in accordance with one embodiment of the present invention. This process may be completed entirely autonomously, substantially autonomously, or by the request of a person or other program.

In step 502, Data Collection Module 406 identifies Topics. The Topic is any entity (e.g. person, place, or thing (e.g. group, company, or the like)) which can be located or identified on a Content Source. The quantity of information related to the Topic is of little relevance in the identification of the Topic. The content sources are online sources which could contain information about a Topic. In one embodiment, the Topics can be queried through a search or analysis of social media sites (such as, but not limited to, Facebook®, LinkedIn®, or Wikipedia® (together considered “Content Networks”), and the like in which pages and groups are often dedicated to Topics. In another embodiment the data collection module 406 access various map or location sources to identify Topics based on geographical data. For Topics with an address, map data provided by tools such as Google® Maps can product huge quantities of Topics (more than 13 million are available today in Google® Maps). In some embodiments, the data collection module 406 accesses source lists of Topics via specialized list providers. These lists may be purchases or accessed freely, for example the yellow and/or white pages or other directories of entities. In another embodiment, the data collection module 406, builds a list by evaluating common search phrases in common search engines. For example, current trending keywords are “Schamburg” (a place), “Illinois” (a place), “NBA” (a thing), & “Tropper” (a person). Each Topic is stored in database 408. The data collection module 406 may initiate countless times through the input of a multitude of Topics found.

In step 504, Data Collection Module 406 compiles a list of Topics. The data collection module 406 compiles a list of all the Topics identified in the content sources and content networks. This list is reviewed to determine duplicate entries and entries which are outside of any predetermined parameters set by the data collection module 406. In some embodiments, the data collection module 406 is able to identify a single Topic through more than one source. The connection between the sources and Topic is recorded and stored. For example, if the search is directed towards entities only within the United States, and entities identified outside the boarders of the United States are removed from the Topic list.

In step 508, Data Collection Module 406 queries the content sources for Topic related content (also referred to as content items). Once the Topic is identified, the data collection module 406 parses all of the known content sources for content related to the Topic. In some embodiments, in the prior steps, the data collection module 406 marks or identifies specific content sources which have content related to the Topic to reduce the time spent. The data collection module 406 may query the totality of content sources where the Topic may be represented, with the now narrowed down Topic. In some embodiments, the data collection module 406 is searching for specific types of content related to the Topic, for example items found in a web presence could be a website address, a microsite, a page on a review site, a wiki page, or a social media point of presence (e.g., a LinkedIn company page and/or group, a Facebook business/brand/product page, or a Twitter account). The Topic content type may be, but not limited to, textual data, geospatial data, image data, video data, audio data, or the like which can be created about the Topic. Each and every Content Source found to be associated with the Topic is stored as a Content Source for the specific Topic in the database 408. Topics may have an unlimited number of Content Sources, as new sources may come into existence throughout this process. Sometimes a single Content Source may identify a single Topic multiple times related to multiple content types. For example, Facebook may have a Content Source associated with new posts, another for events and another for photos/videos. The data collection module 406 also crawls (using a technology such as PHP's CURL library) the Topic's current website if one exists. The crawl searches the website for any direct links to 3rd party Content Source including calendar .ics files. For example, an HTML widget to show a twitter feed would cause the entity's twitter URL to be extracted as a Content Source. The sourcing of the Topic provides a location to, if determined, to link the content to, to provide reference for updating content, and to determine the authenticity of the data.

In step 510, Data Collection Module 406 extracts content from the content sources. The content which is extracted is either directly stored on a database 408. In another embodiment, the content sources are linked or referenced to the specific location of the content. In the instances where a connection or link is created between the content and the database 408 may be based on the size and volume of the content. Often, new content is posted by the Content source and therefore received via API by a program listener (i.e. Web Hook). Some Content sources offer content via a manual request-based API request of some kind and others require a web crawler. In some embodiments, each Content Source periodically offer additional content items and/or updates of existing content items, these updated or additional content items are stored or referenced by the data collection module 406. The data collection module 406 extracts the new or updated content via a listener, API or other form as required by the Content source. The Content Items received from the Content source often are in the form of a JSON Object but may also be a HTML snippet, XML or other type of packaging.

In some embodiments, the Content Items are gathered and analyzed to determine if they are correctly associated with the Topic or if the Item(s) were incorrectly gathered. When incorrect Content Items have been gathered, the Data Collection Module 406 removes or hides the relevant Content items. For example, with several entities having similar or the same name, the data collection module 406 may incorrectly assume that the content items are all related to one Topic, after the content is extracted, the data collection module 406 is able to further analyze the data through various machine learning, artificial intelligence, or deep learning models to sort out content items and Topics.

In step 512, the data collection module 406 decompiles the content. Due to this wide array of potential forms of the Content Items received, the Content Items needs to be decompiled and meta data may need to be removed. The final form of the content is broken into a common set of fields associated with each Content Type. For example, an “Event” Content Type will have fields such as start time, end time, title and description. Those fields will be the ones used for insertion into the database and determined to be a Content Type of “Event.” The categorization of the Content Items is performed by identifying various attributes such as XML data, headings and meta data passed by the Content Network. In some embodiments, the Content Source itself is associated with a specific Content Type. For example, a YouTube source would be auto categorized as a “Video” Content Type. The decompiled Content Items is stored in database 408 to be accessed by design module 407, which takes the decompiled and categorized Content to populate the website.

FIG. 6 depicts a diagram 600 of the operational steps taken to locate Topics based on searching various Content Sources 602, according to an embodiment of the present invention. The data collection module 406 searches the various accessible (either publicly or through permission of private) websites to collect a vast array of Topics. In the depicted embodiment, the Content Sources 602 are shown grouped into like categories, e.g. social media, map data, lists & databases, and search terms. In additional embodiments, the Content Sources 602 are not identified or able to be grouped until after they are first searched. These searches may be simultaneously, or in series based on predetermined factors established the data collection module 406. As each Topic is found, the Topic is stored in database 408. Where a Topic is identified in multiple Content Sources, the Topic may be identified as priority Topics. In some embodiments, when a Topic is located, the Topic is stored based on the Vertical of the Topic, where the Vertical is a group of like Topics e.g. barber shops, auto mechanics, companies, charitable organizations, etc. This is not an exhaustive list of the Content Sources 602, various other Content Sources 602 known to one skilled in the art may be located or searched for Topics.

FIG. 7 depicts a diagram 700 of the operational steps taken identify Content Sources for the Topic, according to an embodiment of the present invention. The data collection module 406 searches the various Content Networks 702 to relocate or identify relevant Content Sources to be used for the collection of Content Items. The queries may happen in series based on the Content Network 702 type or may happen based on various other factors such as spelling, a predetermined importance calculation, or the like. In some embodiments, the Content Networks 702 are continuously searched for new or updated Content Sources. In other embodiments the Content Networks 702 are searched at predetermined intervals, or only upon request by a third party. The Content Sources found as a result of these queries are stored in database 408, or a link to the Content Source is stored. If the Content Source was previously known, the data collection module 406 may skip the location of the Content Source or may mark the Content Source for each iteration that it is located. In some embodiments, a single Content Source may be associated with a plurality of Topics. In the depicted embodiment, the queries are shown directed to specific Content Networks 702 and the Content Sources which were previously identified to be associated with these Content Networks 702. This is not an exhaustive list of the Content Networks 702, various other Content Networks 702 known to one skilled in the art may be located or searched for Topics.

FIG. 8 depicts a diagram 800 of the operational steps taken to categorize Content Items retrieved from Content Sources 602, according to an embodiment of the present invention. The depicted diagram shows the identified Content Sources 602 associated with a Topic. In some embodiments, the Content Sources 602 are sectioned into groups based on their Vertical to increase the efficiency at which the data collection module 406 may parse through the Content Sources 602 to extract the Content Items. The identified or collected Content Items are then sorted into Content Types 802. The data collection module 406 extracts the relevant or predetermined Content Items from the Content Sources 602 and assigns each Content Item a specific Content Type 802 based on the meta data or other identifying information about the Content Items. This assignment of the Content Type may occur after the Content Item is decompiled, or the decompiling may happen substantially at the same time as the extraction of the Content Item. In some instances the data collection module 406 may have preset Content Types 802 based on the Content Source 602, or have prior data based on Content Items which were extracted from the Content Source 602 for other Topics, that the data collection module 406 preemptively knows or is able to identify the Content Type 802 from the Content Source 602. In additional embodiments, the data collection module 406 may search each Content Source 602 for one specific Content Type 802, at a time, then repeat with other Content Types 802. In other embodiments, the data collection module 406 may search the Content Sources 602 for all types of Content Items at once. In instances where the Content Source was previously located and searched, the data collection module 406 may search for more recent versions of already known Content Items or modified Content Items.

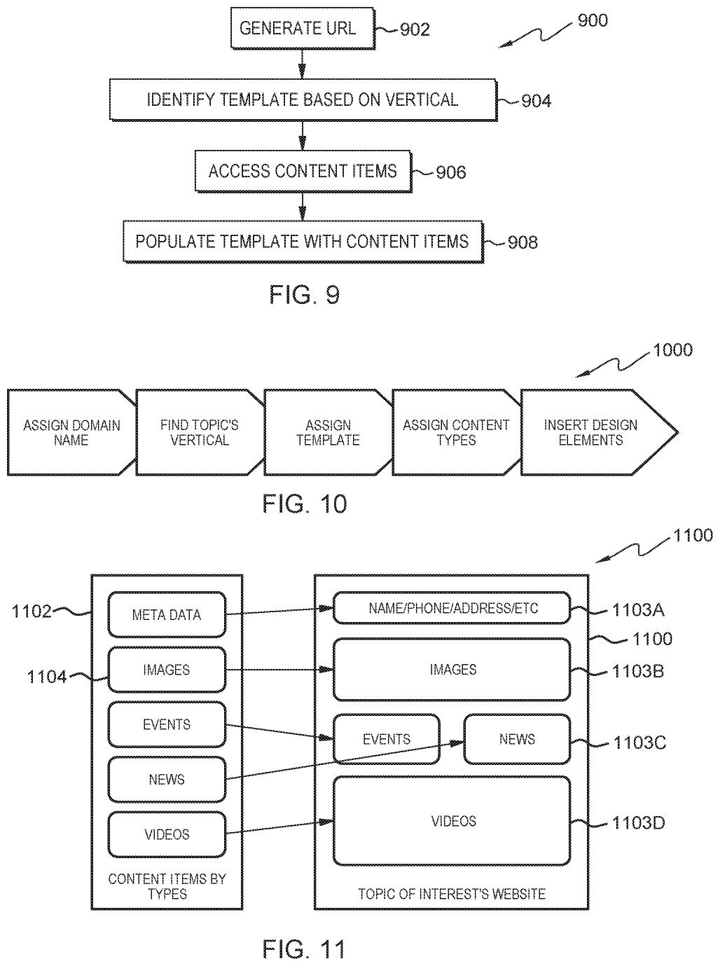

FIG. 9 depicts flowchart 900 depicting a method according to the present invention. The method(s) and associated process(es) are now discussed, over the course of the following paragraphs, with extensive reference to FIG. 9, in accordance with one embodiment of the present invention.

In step 902, Design Module 407 generates a Uniform Resource Locator (URL) for each Topic. For each Topic identified for inclusion in this process, the Design Module 407 generates an entity specific URL. The URL provides the web site address for the Topic to access directly.

In step 904, Design Module 407 identifies the Topic's Vertical. For each Topic identified, the design module 407 identifies the Verticals associated with the Topic. The Vertical is associated with a certain type of Topic which a Template has been generated for. In some instances, more than one template has been generated for one Topic type and several templates may work for multiple Topic types. The Vertical may be, for example, for barber shops, law offices, coffee shops, accountants, non-profit organizations, or the like. The Verticals are related to these different Topic types based on predetermined template designs to effectively display the Content Items which are typical to these Topic types. Through the identification of the templates based on the Topic's Vertical, the design module 407 is able to select the correct template. In some embodiments, where multiple templates are available, the design module 407 selected the template based on the stored Content Items.

The templates are predesigned layouts (see FIG. 11) based on the Vertical of the Topic. In some embodiments, the design module 407 determines if a new template can be generated for the Topic based on the collected Content Items.

In step 906, the design module 407 accesses the Content Items associated with the Topic. As the content has been pre-sorted and decompiled by the data collection module 406, the design module 407 is able to easily locate the specific Content Items. In some embodiments, the design module 407 accesses a selection of the Content Items based on the selected template. In this selection process, the design module 407 may have predetermined requirements to select the most recent Content Items of each Content Type.

In some embodiments design module 407 analyzes the accessed Content Items to determine if the Content Items accessible are adequate to file the template to a predetermined percentage. In additional embodiments, each template may have a minimum requirement of Content Items which are needed to produce a website that would be “complete” or populated to a certain percentage based on the data entries within the template. The template has a location for each Content Item based on the Content Type, If the design module 407 determines that there is adequate content, the design module 407 may proceed to identify the template which is selected to be populated for the Topic. If the design module 407 determines there is inadequate Content Items to populate a previously designed template. The design module 407 analyzes the collected Content Items to determine if other templates may be appropriate for the quantity and types of Content Items accessed. In some embodiments, the design module 407 may create a new template based on the accessed Content Items. In other embodiments, the designed module 407 waits until adequate Content Items are collected by the data collection module 406.

In some embodiments, design module 407 accesses a plurality of templates which are designed for various Topics. The template selected may be based on the content collected or accessed, or specific to certain Topics. The template consists of a layout and design items customized for the type (or ‘Vertical’) of the Topic. For each template, Content Types are identified to allow design module 407 to insert the proper Content Item(s) The locations are sections of the website which are designed for specific types of content. For example, an address or contact information is one Vertical, photos are another Vertical, videos are another Vertical, etc. The placement of these Verticals within the website are predetermined or selected by the design module 407 to create an aesthetically pleasing and functioning website.

In step 908, Design Module 407 populates the template with the Content Items.

Based on the template design, the design module 407 populates the template. Each entry space for the template is associated with a certain Content Type. The Design module 407 inputs the proper Content Item, based on the Content Type, into the entry form. In some embodiments, the design module 407 takes the most recent Content Item for the Content Type to override outdated or now inaccurate information.

In some embodiments, the design module 407 is able to chronologically order Content Items for an entry based on the data associated with each Content Items. In some embodiments, as the design module 407 identifies resolution or images, and length of articles or text documents may adjust or modify to properly fit within the template design. In other embodiments, the template is edited to accommodate the size of an image, the length of an article, or the like. The modifications are to maintain a user-friendly, functioning, (both web based and mobile designed) and aesthetically pleasing experience when viewing the website, while also maintaining the desired amount of content related to the Topic. In some embodiments, this step is substantially continuously performed as the data collection module 406 gathers new data about the Topic

In some embodiments, the data collection module 406 enables access to 3rd party applications for generation of the website based on the collected Content Items. In this embodiment the data collection module 406 delivers to a website publishing program the Content Items. In that case, the website publishing program uses the Content Items received by adding design elements around the Content and then organizes the Content Items into a website. In additional embodiments, the data collection module 406 could be used to empower an application seeking to combine news feeds or event feeds across many entities using a commonality like geographic proximity or other entity characteristics. The data collection module 406 enables 3rd party access via API consists of any conventional server architecture to allow the queuing and responding to requests.

FIG. 10 depicts a flowchart 1000 of building a template, according to an embodiment of the present invention. The flowchart identifies the additional steps of assigning the Content Types based on the Topic's identified Vertical. This assists the design module 407 in removing the need to access or requesting access to Content Types that are not necessary for the Template. The additional step of inserting design elements into the Template. The design elements are external from the Content Items and are used to provide a more visually pleasing website design. These design elements may be based on the Template, the Vertical, the Topic, or Content Items which are located and identified as design elements.

FIG. 11 depicts a diagram of a Template 1101 design. In the depicted embodiment, the template 1100 is shown having a plurality of entry fields 1103A-D which are associated with specific Content Items 1104 that are categorized by Content Types 1102. Each Content Type 1102 have predetermined entry field(s) where the design module 407 populates the Content Items 1104 into. In the depicted embodiment, the template has entry fields for Name/Address/Phone, Images, Events, News, and Videos each with corresponding Content Types 1102 which are associated with the entry fields and Content Items 1104 to populate those fields. In some embodiments, the design module 407 may shift or adjust entry fields based on the absence of Content Items. For example, in the shown embodiment, if no Content Items are present to populate the IMAGES entry field 1103B, the design module 407 may shift the EVENTS and NEWS data fields 1103C up to be positioned below entry field 1103A.

As noted above, the mechanisms of the illustrative embodiments may be utilized with the inputs/outputs of any neural network models, machine learning models, or the like, regardless of the particular artificial intelligence operations performed by the neural network models, machine learning models, or the like. Moreover, although not shown explicitly the neural network model, machine learning model, deep learning or cognitive model, or the like, may be part of a more complex cognitive system that implements such a model to perform a complex cognitive operation, such as natural language processing, image analysis, or any of a plethora of other cognitive operations, as described hereafter.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

What is claimed is:

1. A computer-implemented method comprising:
searching, by one or more processors, a plurality of sources for topics, wherein the topics are associated with distinct entities;
identifying, by one or more processors, a vertical for each of the topics, wherein the vertical is based on the type of distinct entity associated with each topic;
sorting, by one or more processors, the plurality of sources into a group of content sources associated with each of the identified topics;
extracting, by one or more processors, content items from the group of content sources associated with an identified topic;
decompiling, by one or more processors, the group of content items, wherein each of the content items are decompiled into a content type and a set of data;
selecting, by one or more processors, a template based on the topics vertical; and
populating, by one or more processors, the template with the decompiled group of content items, wherein predetermined entries in the template are related to specific content types.

2. The computer-implemented method of claim 1, further comprising, sorting, by one or more processors, the plurality of sources into Content Networks.

3. The computer-implemented method of claim 2, wherein the Content Networks are based on the type or data published by the plurality of sources.

4. The computer implemented method of claim 1, further comprising, identifying, by one or more processors, a group of templates based on the decompiled content items.

5. The computer-implemented method of claim 4, selecting, by one or more processors, a template, based on the decompiled content items populating a predetermined percentage of the selected template.

6. The computer-implemented method of claim 1, further comprising, generating, by one or more processors, a template based on the decompiled content items.

7. The computer-implemented method of claim 1, wherein the content sources are periodically searched for updated or newly created content items.

8. The computer-implemented method of claim 8, further comprising, overwriting, by one or more processors, the updated content items, with the previously extracted content items.

9. A computer program product for generating a web site,
the computer program product comprising a computer readable storage medium having program instructions embodied therewith, the program instructions executable by one or more processors to cause the computing device to:
program instructions to search a plurality of sources for topics, wherein the topics are associated with distinct entities;
program instructions to sort the plurality of sources into a group of content sources associated with each of the topics;
program instructions to extract content items from the group of content sources associated with the topic;
program instructions to decompile the group of content items;
program instructions to select a template; and
program instructions to populate the template with the decompiled group of content items.

10. The computer program product of claim 10, further comprising, program instructions to identify a vertical for each of the topics, wherein the vertical is based on the type of distinct entity associated with each topic.

11. The computer program product of claim 11, further comprising, program instructions to select a template based on the topics vertical; and

12. The computer program product of claim 9, further comprising, select a template from a group of templates based on the verticals.

13. The computer program product of claim 10, further comprising, program instructions to sort the plurality of sources into Content Networks.

14. The computer program product of claim 14, wherein the Content Networks are based on the type or data published by the plurality of sources.

15. The computer program product of claim 10, further comprising, program instructions to identify a group of templates based on the decompiled content items.

16. A system comprising:
a CPU, a computer readable memory and a computer readable storage medium associated with a computing device;
program instructions to search a plurality of sources for content topics, wherein the content topics are associated with individual entities;
program instructions to sort the plurality of sources into groups based on the content topics associated with each of the sources from the plurality of sources;
program instructions to extract content items associated with the content topic from the group of relevant sources;
program instructions to decompile the content items, wherein each of the content items are decompiled into a set of data; and
program instructions to populate a template with the decompiled content items based on the content types, wherein a website is formed.

17. The system of claim 16, further comprising, program instructions to select a template from a group of templates based on the decompiled content items.

18. The system of claim 16, further comprising, program instructions to sort the content items based on a determined content type.

19. The system of claim 16, wherein the template has a plurality of entry types, and the decompiled content items are inserted into the entry types based on the content types.

20. The system of claim 16, further comprising program instructions to assign a content type to each extracted content items.
